(19) United States
(12) Patent Application Publication
(10) Pub. No.: US 2023/0393273 A1
(43) Pub. Date: Dec. 7, 2023

(54) ULTRASONIC SENSOR

(71) Applicant: DENSO CORPORATION, Kariya-city (JP)

(72) Inventors: Masayoshi SATAKE, Nisshin-city (JP); Yu KOYAMA, Nisshin-city (JP); Haruka AOSHIMA, Nisshin-city (JP); Tetsuya AOYAMA, Kariya-city (JP)

(21) Appl. No.: 18/453,959

(22) Filed: Aug. 22, 2023

Related U.S. Application Data
(63) Continuation of application No. PCT/JP2022/000770, filed on Jan. 12, 2022.

(30) Foreign Application Priority Data
Feb. 24, 2021 (JP) 2021-027656

(51) Int. Cl. G01S 15/931

(52) U.S. Cl. CPC G01S 15/931; G01S 2015/938

(57) ABSTRACT

An ultrasonic sensor installable to a vehicle includes a shield section, a vibration conversion section, and an electric circuit section. The shield section includes a conductive layer. The conductive layer is bonded to an outer plate, which is a body part formed of non-conductive material, on an inner surface side of the outer plate. A vibration conversion section, which has a function of converting ultrasonic vibration and electrical signals, is bonded to the shield section to enable ultrasonic vibration together with the outer plate. An electric circuit section is electrically connected to the vibration conversion section to enable the transfer of the electric signals to and from the vibration conversion section. The shield section is electrically short-circuited to a ground side line electrically connected to the electric circuit section to shield the vibration conversion section.

### CROSS-REFERENCE TO RELATED APPLICATION

This application is the U.S. bypass application of International Application No. PCT/JP2022/000770, filed on Jan. 12, 2022 which designated the U.S. and claims priority to Japanese Patent Application No. 2021-027656, filed on Feb. 24, 2021, the contents of both of which are incorporated herein by reference.

### TECHNICAL FIELD

The present disclosure relates to an ultrasonic sensor installable to vehicles.

### BACKGROUND

Conventionally, there is a known configuration in which an ultrasonic sensor is mounted on a bumper so that a through hole is formed in the bumper of a vehicle and the vibration surface of the ultrasonic sensor is exposed to the outside through this through hole. However, such a configuration was not very desirable from a design standpoint because it formed a through hole in the bumper. In order to “retrofit” a vehicle without such an ultrasonic sensor, which is a vehicle originally shipped from the factory without such a sensor, it is necessary to form a through-hole in the bumper. Therefore, it has been difficult to “retrofit” such ultrasonic sensors to non-equipped vehicles.

In contrast, various configurations have been proposed in the past in which an ultrasonic sensor equipped with an ultrasonic transducer is fixed to the inner surface of a bumper, thereby including the bumper as a vibration surface for the ultrasonic transducer (see, for example, JP 3469243 B).

### SUMMARY

According to one aspect of the present disclosure, an ultrasonic sensor installable to a vehicle includes:

a shield section including an outer surface facing an external space of the vehicle and an inner surface on the back side of the outer surface, the shield section further including a conductive layer bonded to an outer plate on the inner surface side of the outer plate, which is a body part formed from non-conductive material;

a vibration conversion section having a function of converting ultrasonic vibration and electrical signals, and being bonded to the shield section to enable ultrasonic vibration together with the outer plate; and

an electric circuit section electrically connected to the vibration conversion section to enable the transfer of the electric signals to and from the vibration conversion section; wherein

the shield section is electrically short-circuited to a ground side line electrically connected to the electric circuit section to shield the vibration conversion section.

### BRIEF DESCRIPTION OF THE DRAWINGS

The above features of the present disclosure will be made clearer by the following detailed description, given referring to the appended drawings. In the accompanying drawings:

FIG. 1 shows a perspective view of an exterior of a vehicle equipped with an ultrasonic sensor of an embodiment;

FIG. 2 shows a cross-sectional view of a schematic configuration of a first embodiment of the ultrasonic sensor shown in FIG. 1;

FIG. 3 shows a cross-sectional view of a schematic configuration of a second embodiment of the ultrasonic sensor shown in FIG. 1;

FIG. 4 shows a cross-sectional view of a schematic configuration of a third embodiment of the ultrasonic sensor shown in FIG. 1; and

FIG. 5 shows a cross-sectional view of a schematic configuration of a fourth embodiment of the ultrasonic sensor shown in FIG. 1.

### DETAILED DESCRIPTION OF THE PREFERRED EMBODIMENTS

Ultrasonic sensors installed in vehicles are used in a variety of electromagnetic noise environments. In this regard, in the conventional configuration where the ultrasonic sensor is fixed to the inner surface of the bumper that does not have a through hole, there was concern that electromagnetic noise could flow to the ultrasonic transducer, causing it to malfunction or fail, or that noise could be radiated to the outside when the ultrasonic transducer is driven.

The present disclosure has been made in view of the circumstances and the like exemplified above. In other words, the present disclosure provides, for example, an ultrasonic sensor having a configuration that can be mounted on a body part of a vehicle without a through hole in the body part, such as a bumper, and having excellent EMC characteristics. Note that EMC stands for Electromagnetic Compatibility.

According to one aspect of the present disclosure, an ultrasonic sensor installable to a vehicle includes:

a shield section including an outer surface facing an external space of the vehicle and an inner surface on the back side of the outer surface, the shield section further including a conductive layer bonded to an outer plate on the inner surface side of the outer plate, which is a body part formed from non-conductive material;

a vibration conversion section having a function of converting ultrasonic vibration and electrical signals, and being bonded to the shield section to enable ultrasonic vibration together with the outer plate; and

an electric circuit section electrically connected to the vibration conversion section to enable the transfer of the electric signals to and from the vibration conversion section; wherein

the shield section is electrically short-circuited to a ground side line electrically connected to the electric circuit section to shield the vibration conversion section.

Embodiments of the present disclosure are described in the following referring to the accompanying drawings. Note that various modifications applicable to one embodiment may hinder the understanding of the embodiment if they are inserted in the middle of a series of explanations about the embodiment. For this reason, the modifications will not be inserted in the middle of the series of explanations regarding the embodiment, but will be explained collectively afterwards.

(On-Board Configuration)

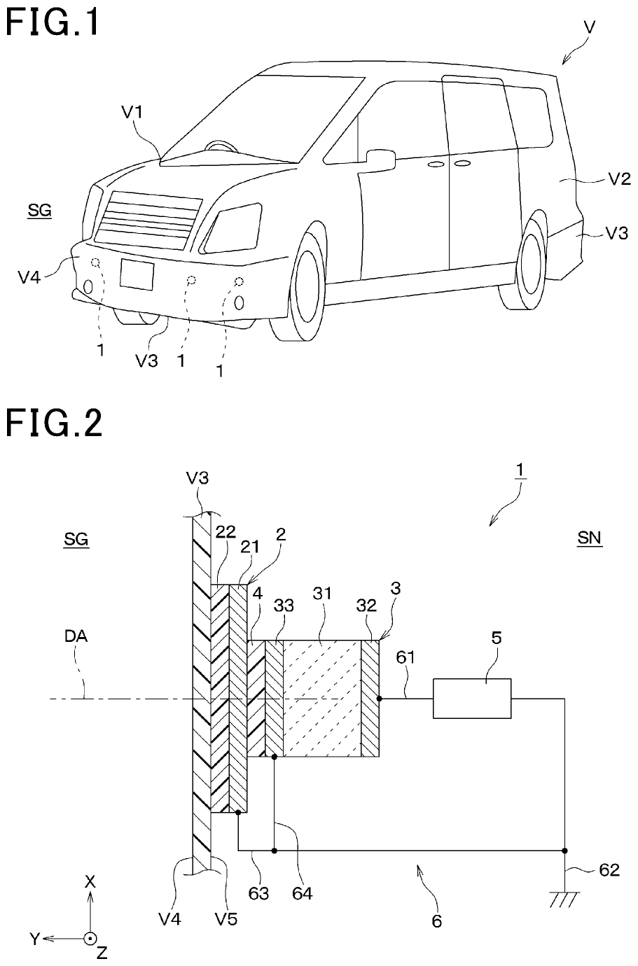

Referring to FIG. 1, in the present embodiment, an ultrasonic sensor 1 is configured as an on-board clearance sonar with a vehicle V as a mounting target. In other words, the ultrasonic sensor 1 is configured to be installed in the vehicle V to enable detection of objects existing around the vehicle V.

The vehicle V is a so-called four-wheeled vehicle, and equipped with a box-shaped vehicle body V1. The vehicle body V1 is fitted with vehicle body panels V2 and bumpers V3, which are vehicle body parts that constitutes a vehicle outer plate. The vehicle body panel V2 is formed of conductive metallic material (e.g., steel plate). The bumper V3 is located at each of the front and rear ends of the vehicle body V1. The bumper V3 is formed of a non-conductive material (e.g., insulating synthetic resin).

In the present embodiment, the ultrasonic sensor 1 is configured to detect objects in an external space SG of the vehicle V by being attached to the bumper V3. A state in which the ultrasonic sensor 1 is mounted on a vehicle V, i.e., a bumper V3, is hereinafter referred to as a “mounted state”.

Specifically, in the mounted state, a plurality of (e.g., four) ultrasonic sensors 1 are mounted on a front bumper, i.e., the bumper V3 on the front side of the vehicle body V1. The plurality of ultrasonic sensors 1 mounted on the front bumper are each located at different positions in a vehicle width direction. Similarly, although not shown, a plurality of (e.g., four) ultrasonic sensors 1 are mounted on a rear bumper, i.e., the bumper V3 on the rear side of the vehicle body V1.

In the present disclosure, the bumper V3 is not provided with mounting holes, which are through holes for mounting the ultrasonic sensor 1. In other words, the ultrasonic sensor 1 has a configuration that allows retrofitting without drilling mounting holes in the bumper V3 for vehicles not equipped with ultrasonic sensors, which are vehicles V that were once shipped from the factory without ultrasonic sensors being equipped. The details of the ultrasonic sensor 1 with such a configuration are described below.

### First Embodiment

FIG. 2 shows one of the plurality of ultrasonic sensors 1 mounted on the bumper V3 in the mounted state. The schematic configuration of the ultrasonic sensor 1 of the first embodiment is described below with reference to FIGS. 1 and 2.

In the present embodiment, the ultrasonic sensor 1 is configured to transmit and receive ultrasonic waves. In other words, the ultrasonic sensor 1 has an integrated transmitter/receiver configuration.

Specifically, the ultrasonic sensor 1 is configured to transmit probe waves, which are ultrasonic waves, along a directional axis DA toward the external space SG. The directional axis is an imaginary straight line extending from the ultrasonic sensor 1 along the direction of ultrasonic wave transmission and reception, and is a reference for a directional angle. The directional axis may also be referred to as a directional center axis or a detection axis. Further, the ultrasonic sensor 1 is configured to receive waves including reflected waves of probe waves by objects existing around the vehicle V from the external space SG, and to generate and output detection signals according to the reception results of the received waves.

For convenience of explanation, a right-handed XYZ Cartesian coordinate system is set up so that the Y axis is parallel to the directional axis DA and the Z axis is parallel to a direction of action of gravity, i.e., a vehicle height direction, in planar view, as shown in FIG. 2. The term planar view shall mean looking at a component from above downward with a line of sight parallel to the direction of action of gravity.

A direction parallel to the directional axis DA is referred to as an axial direction. A tip side in the axial direction is a direction from which the probe waves are transmitted, and corresponds to the Y-axis positive direction in FIG. 2. In contrast, a base end side in the axial direction corresponds to the Y-axis negative side in FIG. 2. Any direction orthogonal to the axial direction is referred to as an in-plane direction. The in-plane direction is a direction parallel to the XZ plane in FIG. 2. The in-plane direction is a direction parallel to the XZ plane in FIG. 2.

The bumper V3 has a bumper outer surface V4 and a bumper inner surface V5. The bumper outer surface V4 faces the external space SG, which is the space outside the vehicle V. The bumper inner surface V5 is a back surface of the bumper outer surface V4 and faces an inner space SN, which is a space inside the vehicle V, or the bumper V3.

The ultrasonic sensor 1 is fixed to the bumper inner surface V5 while being housed in the inner space SN in the mounted state. Then, the ultrasonic sensor 1 is configured to transmit probe waves by vibrating the bumper V3 and to generate a detection signal by converting the vibration of the bumper V3 caused by the received wave into an electrical signal. Specifically, the ultrasonic sensor 1 has a shield section 2, a vibration conversion section 3, an element adhesion layer 4, an electric circuit section 5, and a wiring section 6. Each part constituting the ultrasonic sensor 1 according to the present embodiment will be described below.

The shield section 2 is joined to the bumper inner surface V5 in the mounted state. In the present embodiment, the shield section 2 has a conductor layer 21 that is joined to the bumper V3 on the bumper inner surface V5 side. Specifically, the conductor layer 21 is joined to the bumper inner surface V5 by a shield adhesive layer 22. In other words, the shield section 2 has the conductor layer 21 and the shield adhesive layer 22. The conductor layer 21 is formed by a thin metal layer or metal film, such as copper foil. The shield adhesive layer 22, which bonds the bumper V3 and the conductor layer 21, is formed by an adhesive that becomes a hard bonding layer capable of propagating ultrasonic vibration well by solidification (e.g., epoxy adhesive).

The shield section 2 has a larger in-plane shape than that of the vibration conversion section 3 so that the shield section 2 can shield the vibration conversion section 3 by being set to a reference potential on the ground side (i.e., ground potential, specifically about 0 V). In other words, if defining a contour shape as an external shape projected onto a virtual plane orthogonal to the directional axis DA, a contour shape of the vibration conversion section 3 is positioned inside a contour shape of the shield section 2.

The vibration conversion section 3 has the function of converting ultrasonic vibration and electrical signals, and is joined to the shield section 2 so that the vibration conversion section can vibrate ultrasonically together with the bumper V3. In the present embodiment, the vibration conversion section 3 is configured as a piezoelectric element, a type of electrical-mechanical energy conversion device. Specifically, the vibration conversion section 3 has a piezoelectric material layer 31, a drive electrode 32, and a reference electrode 33.

The piezoelectric material layer 31 is formed by a piezoelectric material such as lead zirconate titanate (i.e., PZT). The piezoelectric material layer 31 is disposed between the drive electrode 32 and the reference electrode 33 in the axial direction. Specifically, the drive electrode 32 is a metallized layer, or metal film, bonded to an end face of the base end side of the piezoelectric material layer 31 in the axial direction, and is formed on the piezoelectric material layer 31. The reference electrode 33 is a metallized layer bonded to an end face of the tip side of the piezoelectric material layer 31 in the axial direction, and is formed on the piezoelectric material layer 31.

The vibration conversion section 3 is bonded to the shield section 2 by means of the element adhesion layer 4. The element adhesion layer 4, which bonds the shield section 2 and the vibration conversion section 3, is formed by an adhesive that becomes a hard bonding layer capable of propagating ultrasonic vibration well by solidification (e.g., epoxy adhesive). In the present embodiment, the element adhesion layer 4 is bonded to the conductor layer 21 in the shield section 2 and the reference electrode 33 in the piezoelectric material layer 31.

The electric circuit section 5 is electrically connected to the vibration conversion section 3 so that electrical signals can be exchanged with the vibration conversion section 3. n the present embodiment, the electric circuit section 5 is configured to output a drive signal to the vibration conversion section 3 to drive the vibration conversion section 3 to transmit probe waves. In addition, the electric circuit section 5 is configured to detect objects around the vehicle V by processing the received signal output from the vibration conversion section 3, which is excited by the reception of the received wave.

The wiring section 6 has a signal line 61, a ground side line 62, a shield ground line 63, and an electrode ground line 64. The signal line 61 is disposed to electrically connect the drive electrode 32 in the vibration conversion section 3 to signal input/output terminals in the electric circuit section 5. In other words, the vibration conversion section 3 and the electric circuit section exchange drive and receive signals via the signal line 61.

The ground side line 62 is disposed to ground a ground terminal in the electric circuit section 5. The shield ground line 63 is disposed to electrically connect the conductor layer 21 and the ground side line 62 in shield section 2. In other words, the shield section 2 is electrically short-circuited to the ground side line 62 via the shield ground line 63 to shield the vibration conversion section 3. The electrode ground line 64 is disposed to electrically connect the reference electrode 33 in the vibration conversion section 3 to the ground side line 62.

### Effects

The following is an overview of the operation of the ultrasonic sensor 1 of the present embodiment having the above configuration, together with the effects produced by the same configuration, with reference to the respective drawings.

At the time of transmission when the probe waves are transmitted, the electric circuit section 5 outputs a drive signal to the vibration conversion section 3. This causes the vibration conversion section 3 to vibrate ultrasonically. Then, the ultrasonic vibration in the vibration conversion section 3 propagates to the bumper V3 through the element adhesion layer 4 and the shield section 2, and the bumper V3 is excited at a frequency in the ultrasonic band. Specifically, the bumper V3 vibrates ultrasonically so that it flexes in the thickness direction, or axial direction, at the position where it intersects the directional axis DA. Such ultrasonic vibration of the bumper V3 propagates into the air in the external space SG, and the probe waves are transmitted along the directional axis DA toward the external space SG.

At the time of reception, the bumper V3 is excited by the received wave propagated from the external space SG to the bumper V3. Specifically, the bumper V3 vibrates ultrasonically so that it flexes in the thickness direction at the position where it intersects the directional axis DA. The ultrasonic vibration in the bumper V3 then propagates to the vibration conversion section 3 via the element adhesion layer 4 and the shield section 2. As a result, the vibration conversion section 3 generates a received signal corresponding to the frequency and intensity of the received wave. The received signal generated by the vibration conversion section 3 is processed by the electric circuit unit 5, so that the ultrasonic sensor 1 detects surrounding objects.

Thus, the ultrasonic sensor 1 has a configuration that includes the bumper V3 as the vibrating surface of the ultrasonic transducer. In such a configuration, it is not necessary to form a mounting hole, a through hole, in the bumper V3 for mounting the ultrasonic sensor 1. In addition, it is not necessary to provide some structure on the bumper outer surface V4 for transmitting and receiving ultrasonic waves. Therefore, such a configuration makes it possible to provide an ultrasonic sensor 1 with excellent design. It is also possible to “retrofit” the ultrasonic sensor 1 without forming mounting holes in the bumper V3 for vehicles not equipped with ultrasonic sensors.

As described above, the ultrasonic sensor 1 is housed inside the bumper V3 as a body part that constitutes the outer panel of the vehicle body V1, and is attached to such bumper V3. Specifically, the ultrasonic sensor 1 is bonded to the bumper inner surface V5. By the way, the ultrasonic sensor 1 installed in a vehicle V is used in a variety of electromagnetic noise environments. In this regard, the bumper V3 made of non-conductive material, which is the object of attachment of the ultrasonic sensor 1 and interposed between the ultrasonic sensor 1 and the external space SG, has no function of shielding electromagnetic noise by itself.

Therefore, the present embodiment has a structure with the shield section 2 at the bonding point to the bumper inner surface V5, which is necessary when the ultrasonic sensor 1 is attached to the bumper V3. In other words, the shield section 2 is disposed between the bumper V3 and the vibration conversion section 3. The shield section 2 is then electrically short-circuited to the ground side line 62 electrically connected to the electrical circuit section 5, thereby shielding the vibration conversion section 3.

According to such a configuration, malfunctions, or failures due to electromagnetic noise flowing into the vibration conversion section 3, or noise radiated outside when the vibration conversion section 3 is driven, can be well prevented from occurring. Therefore, such a configuration makes it possible to provide an ultrasonic sensor 1 with excellent EMC characteristics in a configuration that can be mounted on a bumper V3 without a mounting hole, which is a through hole, in the bumper V3.

Further, in the present embodiment, the vibration conversion section 3 as an electrical-mechanical energy conversion element is fixed to the bumper V3 through the shield section 2 and the element adhesion layer 4, which can be formed in a relatively thin layer. This improves the efficiency of local excitation of bumper V3 for transmitting probe waves, as well as the sensitivity of the received waves.

### Second Embodiment

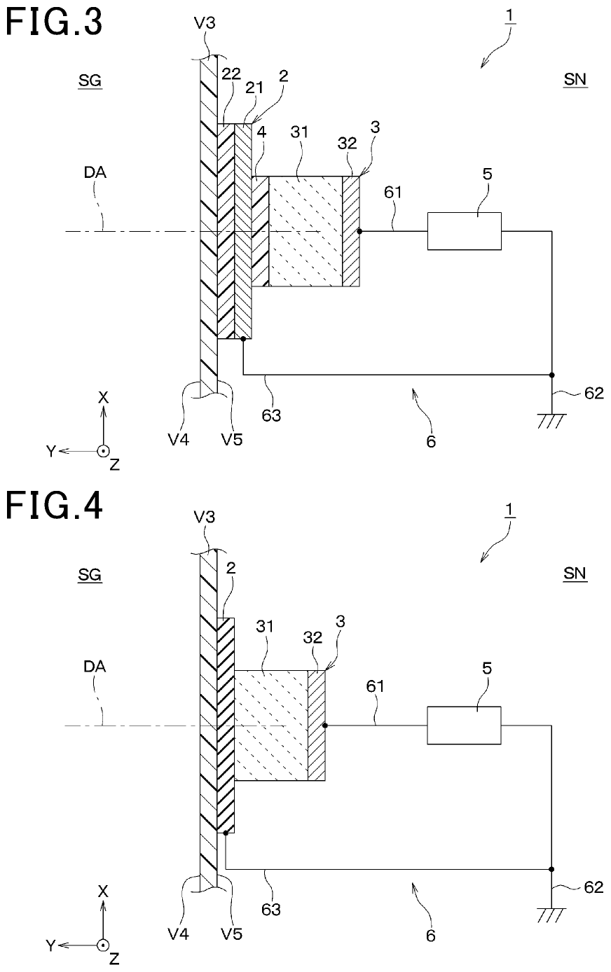

The second embodiment will be described below with reference to FIG. 3. Note that in the following description of the second embodiment, components that differ from the first embodiment above will mainly be explained. In addition, in the first and second embodiments, components that are identical or equal are denoted with the same reference signs. Therefore, in the following description of the second embodiment, with respect to the components having the same reference signs as those of the first embodiment, the description in the first embodiment above may be incorporated as appropriate, unless there is any technical inconsistency or special additional explanation. The same applies to a third and subsequent embodiments described below.

In the present embodiment, a shield section 2 is disposed to constitute one of a pair of electrodes that a vibration conversion section 3 has, which is electrically short-circuited to a ground side line 62 (i.e., the reference electrode 33 in FIG. 2). In other words, the reference electrode 33 shown in FIG. 2, which is disposed on the tip side of the vibration conversion section 3 in the axial direction, is omitted in the configuration shown in FIG. 3 by being substituted by a conductor layer 21 in the shield section 2. In addition, an element adhesive layer 4 is disposed as a bonding layer that bonds a piezoelectric material layer 31 to the conductor layer 21 in the shield section 2.

According to such a configuration, the shield section 2, or the conductor layer 21, functions as one of the pair of electrodes constituting the vibration conversion section 3, as well as shielding the vibration conversion section 3 from electromagnetic noise. Thus, the configuration of the ultrasonic sensor 1 can be further simplified. In addition, the reduction in the number of layers between the piezoelectric material layer 31 and the bumper V3 improves the efficiency of vibration propagation.

### Third Embodiment

The third embodiment is described below with reference to FIG. 4. In the present embodiment, as in the second embodiment above, a shield section 2 is disposed to constitute one of a pair of electrodes that a vibration conversion section 3 has, which is electrically short-circuited to a ground side line 62.

In the present embodiment, the shield section 2 is a conductive layer formed by a conductive adhesive layer that bonds a bumper V3 and the vibration conversion section 3 (i.e., a piezoelectric material layer 31). In other words, the shield section 2 is formed by solidifying an additive (e.g., conductive filler, etc.) added to an adhesive to give conductivity. In other words, the shield section 2 in the present embodiment corresponds to one in which the conductor layer 21, the shield adhesive layer 22, and the element adhesive layer 4 in the above first embodiment, etc. are integrated or unified.

According to such a configuration, the shield section 2, which is a conductive adhesive layer bonding the bumper V3 and the vibration conversion section 3, functions as one of a pair of electrodes constituting the vibration conversion section 3, as well as electromagnetically shielding the vibration conversion section 3. Thus, the configuration of the ultrasonic sensor 1 can be further simplified. In addition, the reduction in the number of layers between the piezoelectric material layer 31 and the bumper V3 improves the efficiency of vibration propagation.

In such a configuration, an acoustic impedance Za of the shield section 2, which is a conductive adhesive layer, is suitably between an acoustic impedance Zb of the bumper V3 and an acoustic impedance Zc of the piezoelectric material layer 31. In other words, it is preferable that either of the following two equations hold.

Zb>Za>Zc

Zb<Za<Zc

As a result, the shield part 2, which is a conductive adhesive layer, functions as an acoustic matching layer, so that the vibration propagation efficiency between the bumper V3 and the vibration conversion section 3 can be further improved.

### Fourth Embodiment

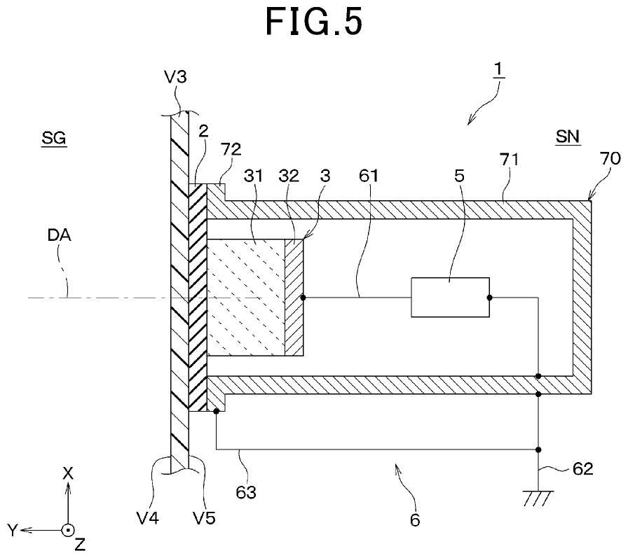

The fourth embodiment is described below with reference to FIG. 5. In the present embodiment, as in the second embodiment above, a shield section 2 is disposed to constitute one of a pair of electrodes that a vibration conversion section 3 has, which is electrically short-circuited to a ground side line 62. In addition, as in the third embodiment above, the shield section 2 is provided as a conductive adhesive layer that bonds a bumper V3 and the vibration conversion section 3.

In the present embodiment, the ultrasonic sensor 1 is further provided with a cover section 70. The cover section 70 is formed of conductive material and disposed to cover the vibration conversion section 3 and an electric circuit section 5. In other words, the cover section 70 is configured to accommodate the vibration conversion section 3 and the electric circuit section 5. Further, the cover section 70 is electrically short-circuited to a ground side lint 62 via a shield ground line 63.

Specifically, the cover section 70 has a body part 71 and a flange part 72. The body part 71 and the flange part 72 are seamlessly formed in one piece by the same conductive material (e.g., a metallic material such as aluminum).

The body part 71 is formed as a bottomed cylindrical shape having a central axis along the directional axis DA and opening at a tip side in the axial direction. In other words, the body part 71 is disposed behind the vibration conversion section 3, i.e., covering a base end side thereof in the axial direction.

The flange part 72 extends in a radial direction from a tip in the axial direction of the body part 71. The radial direction is a direction away from the central axis. That is, the radial direction is the direction in which a half-line extends when the half-line is drawn in a virtual plane starting from the intersection of the central axis and the above virtual plane orthogonal to the central axis. In other words, the radial direction is a radial direction of a circle when the circle is drawn in the virtual plane centered at the intersection of the above virtual plane and the central axis.

The flange part 72 is bonded to the bumper V3 via the shield section 2, which is a conductive adhesive layer. This allows the shield section 2 to be electrically short-circuited to the grounded cover part 70.

According to such a configuration, the vibration conversion section 3 and the electric circuit section 5 are enclosed by the shield section 2, which is formed of conductive material, and the cover part 70, which is formed of conductive material. This allows the vibration conversion section 3 and the electric circuit section 5 to be well electromagnetically shielded. Therefore, it becomes possible to provide an ultrasonic sensor 1 with excellent EMC characteristics in a configuration that can be mounted on a bumper V3 without a mounting hole, which is a through hole, in the bumper V3.

### Modifications

The present disclosure is not limited to the above embodiments. Therefore, modifications can be made to the above embodiments as appropriate. Typical modifications are described below. In the following description of the modifications, the differences from the above embodiment are mainly explained. In addition, in the above embodiments and modifications, components that are identical or equal are denoted with the same reference signs. Therefore, in the description of the following modifications, the description in the above embodiment may be aided as appropriate for components that have the same reference signs as those in the above embodiment, unless there is a technical inconsistency or a special additional explanation.

The present disclosure is not limited to the specific device configuration shown in the above embodiments. That is, the applicable vehicle V is not limited to four-wheeled vehicles, for example. Specifically, a vehicle V may be a three-wheeled vehicle or a six- or eight-wheeled vehicle such as a cargo truck. The type of a vehicle V may be a vehicle equipped only with an internal combustion engine, an electric or fuel cell vehicle without an internal combustion engine, or a so-called hybrid vehicle. The shape and structure of the vehicle body V1 is also not limited to a box shape, i.e., a substantially rectangular shape in planar view.

The mounting target of the ultrasonic sensor 1 is not limited to the bumper V3. Specifically, the ultrasonic sensor 1 may be mounted on a vehicle body panel V2 made of non-conductive material, for example. There is no particular limitation on the non-conductive material that constitutes the non-conductive vehicle body panel V2 and/or the bumper V3 to which the ultrasonic sensor 1 is attached. Thus, for example, such a non-conductive material may be FRP. FRP stands for Fiber Reinforced Plastics.

The ultrasonic sensor 1 is not limited to an integrated transmitter/receiver configuration. That is, for example, the ultrasonic sensor 1 may have a configuration that can only transmit ultrasonic waves. Alternatively, the ultrasonic sensor 1 may only have the function of receiving reflected waves by objects in the surroundings of the probe waves, which is ultrasonic wave transmitted from other ultrasonic transmitters.

The configuration of each part in the ultrasonic sensor 1 is also not limited to the specific examples above. Specifically, for example, the in-plane shape in each part of the shield section 2, vibration conversion section 3, etc. may be circular, oval, square, hexagonal, octagonal, etc.

The conductive material layer in the shield section 2, i.e., conductor layer 21 in FIGS. 2 and 3, and shield section 2 in FIGS. 4 and 5, is suitably formed with a thickness corresponding to the frequency of the electromagnetic noise to be counteracted. Specifically, such thickness t can be set within the range satisfying the following equation. Note that in the following equation, p is electrical resistivity, f is frequency, and μ is absolute permeability.

$$t \geq \sqrt{( \frac{ρ}{π f μ} )}$$

In FIG. 2 and other figures, the vibration conversion section 3 is shown as having a configuration with electrode layers on both sides of a single piezoelectric material layer 31. However, the present disclosure is not limited to such aspects. That is, the vibration conversion section 3 typically has a stacked configuration with several alternating piezoelectric material layers 31 and electrode layers in the axial direction. For this reason, FIG. 2 and other figures have been simplified to show the schematic structure of the present disclosure. Therefore, the present disclosure may be suitably applied to an ultrasonic sensor 1 with a stacked vibration conversion section 3. In addition, the vibration conversion section 3 is not limited to piezoelectric elements, but may also be a capacitive type electrical-mechanical energy conversion element.

The cover part 70 shown in FIG. 5 may also be disposed in the configurations shown in FIGS. 2 and 3. In this case, the flange part 72 may be bonded to the conductor layer 21 in the shield section 2 by a conductive adhesive. In such a configuration, the vehicle-mounted state can be achieved by bonding the sensor unit, which is composed of the conductor layer 21 and the flange part 72, to the bumper V3 by means of the adhesive constituting the shield adhesive layer 22. This can result in a good reduction of installation man-hours.

Without saying that the elements constituting the above embodiments are not necessarily essential, except when expressly stated as being particularly essential, or when they are clearly essential in principle, etc. In addition, when numerical values of the number, amount, range, etc., of components are mentioned, the disclosure is not limited to those specific values, except when specifically stated as essential or when clearly limited in principle to a specific value. Similarly, when the shape, direction, positional relationship, etc. of components, etc. are mentioned, the disclosure is not limited to such shape, direction, positional relationship, etc., except when expressly stated as being particularly essential or when limited to a specific shape, direction, positional relationship, etc. in principle.

Modifications are also not limited to the above examples. That is, for example, a plurality of embodiments, other than those exemplified above, may be combined with each other as long as they are not technically inconsistent. Similarly, multiple modifications may be combined with each other as long as they are not technically inconsistent.

What is claimed is:

1. An ultrasonic sensor installable to a vehicle comprising:
a shield section including an outer surface facing an external space of the vehicle and an inner surface on the back side of the outer surface, the shield section further including a conductive layer bonded to an outer plate on the inner surface side of the outer plate, which is a body part formed from non-conductive material;
a vibration conversion section having a function of converting ultrasonic vibration and electrical signals, and being bonded to the shield section to enable ultrasonic vibration together with the outer plate; and
an electric circuit section electrically connected to the vibration conversion section to enable the transfer of the electric signals to and from the vibration conversion section; wherein
the shield section is electrically short-circuited to a ground side line electrically connected to the electric circuit section to shield the vibration conversion section.

2. The ultrasonic sensor according to claim 1, wherein
the shield section is bonded to the inner surface of the outer plate, and
the vibration conversion section is bonded to the shield section by an adhesive layer.

3. The ultrasonic sensor according to claim 1, wherein
the shielding section is the conductive layer formed by a conductive adhesive layer bonding the outer plate and the vibration conversion section.

4. The ultrasonic sensor according to claim 3, wherein
the vibration conversion section includes a piezoelectric material layer, and
an acoustic impedance of the conductive adhesive layer is set between an acoustic impedance of the outer plate and an acoustic impedance of the piezoelectric material layer.

5. The ultrasonic sensor according to claim 1, wherein
the shield section is disposed to constitute a reference electrode, which is one of a pair of electrodes that the vibration conversion section includes, the reference electrode is electrically short-circuited to the ground side line.

6. The ultrasonic sensor according to claim 1, wherein
the ultrasonic sensor further includes a cover section formed of conductive material configured to cover the vibration conversion section and the electric circuit section, and
the cover section is electrically short-circuited to the shield section.
